(19) United States
(12) Patent Application Publication
(10) Pub. No.: US 2010/0159920 A1
(43) Pub. Date: Jun. 24, 2010

(54) SYSTEM FOR MONITORING RADIATION INTENSITY OF ELECTROMAGNETIC WAVE OF A MOBILE PHONE

(76) Inventor: Hsin-Chang Wu, Tu-Cheng City (TW)

Correspondence Address: Muncy, Geissler, Olds & Lowe, PLLC, 4000 Legato Road, Suite 310, FAIRFAX, VA, 22033, US

(21) Appl. No.: 12/344,122

(22) Filed: Dec. 24, 2008

(51) Int. Cl. H04W 24/00

(52) U.S. Cl. 455/425

(57) ABSTRACT

A system for monitoring radiation intensity of electromagnetic wave of a mobile phone has a systematic part which includes an antenna duplexer, a central processing unit, a radio frequency processing unit disposed between the antenna duplexer and the central processing unit, a power amplify circuit connected between the central processing unit and the antenna duplexer, and a systematic power source connected with the central processing unit and the power amplify circuit. A power monitor unit connected with the systematic part is capable of monitoring a power or a current of the systematic part and comparing the power or the current with a standard power or a standard current to produce a state signal. A light-emitting control circuit connected with the power monitor unit and a display device receives the state signal from the power monitor unit and drives the display device to show information corresponding to the state signal.

### BACKGROUND OF THE INVENTION

1. Field of the Invention

The present invention generally relates to a system of a mobile phone, and more particularly to a system capable of monitoring radiation intensity of electromagnetic wave of a mobile phone.

2. The Related Art

Mobile phones, as communication tools, have been becoming popular and necessary for people at present. The mobile phone, which transmits information by electromagnetic wave, can receive or send audio information at random, because the mobile phone is always receiving or sending electromagnetic signal from or to a base station.

However, as it is known that the intensity of the electromagnetic wave has loss in transmission process. The farther the mobile phone is away from the base station, the weaker the electromagnetic signal is received by the mobile phone. As a result, the mobile phone has to increase the radiation power for guaranteeing normal communication, but which makes the electromagnetic wave radiation of the mobile phone get stronger and results in bad influence on users' well-being. In addition, the buildings and the like also may block the electromagnetic wave transmission so as to make the electromagnetic wave weak. Therefore, there is a need to provide a system of the mobile phone which can monitor radiation intensity of the electromagnetic wave of the mobile phone so that the user can avoid using the mobile phone when the electromagnetic wave radiation of the mobile phone is strong.

### SUMMARY OF THE INVENTION

An object of the present invention is to provide a system which can monitor radiation intensity of electromagnetic wave of a mobile phone. The system has a systematic part which includes an antenna duplexer, a central processing unit, a radio frequency processing unit disposed between the antenna duplexer and the central processing unit, a power amplify circuit connected between the central processing unit and the antenna duplexer, and a systematic power source connected with the central processing unit and the power amplify circuit. A power monitor unit connected with the systematic part is capable of monitoring a power or a current of the systematic part and comparing the power or the current with a standard power or a standard current to produce a state signal. A light-emitting control circuit connected with the power monitor unit and a display device receives the state signal from the power monitor unit and drives the display device to show information corresponding to the state signal.

As described above, the power monitor unit is able to monitor the radiation power or the current of the systematic part and compare the radiation power or the current with the standard power or the standard current to produce the state signal and transmit the state signal to the lighting-emitting control circuit, so that the display device depending on the lighting-emitting control circuit presents the information of the radiation intensity of electromagnetic wave of the mobile phone. Thus, a user can know about the radiation intensity of the electromagnetic wave of the mobile phone and utilize the mobile phone when the electromagnetic wave radiation of the mobile phone is weak.

### BRIEF DESCRIPTION OF THE DRAWINGS

The present invention will be apparent to those skilled in the art by reading the following description of embodiments thereof, with reference to the accompanying drawings, in which:

FIG. 1 is a flow chart describing the execution of a system for monitoring radiation intensity of electromagnetic wave of a mobile phone in a first embodiment in accordance with the present invention; and

FIG. 2 is a flow chart describing the execution of a system for monitoring radiation intensity of electromagnetic wave of a mobile phone in a second embodiment in accordance with the present invention.

### DETAILED DESCRIPTION OF THE EMBODIMENTS

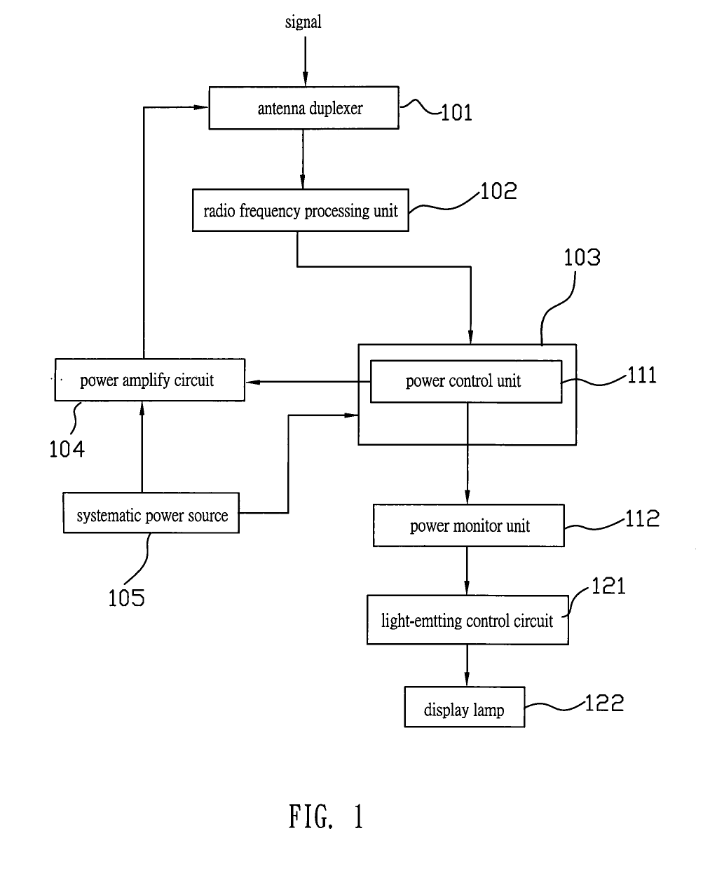

With reference to FIG. 1, a system for monitoring radiation intensity of electromagnetic wave of a mobile phone (not shown) in a first embodiment according to the present invention includes a systematic part, a power monitor unit 112, a light-emitting control circuit 121 and a display device. The systematic part has an antenna duplexer 101 for controlling the mobile phone in use to receive or send signals. The antenna duplexer 101 is connected with a radio frequency processing unit 102. A central processing unit (CPU) 103 is connected with the radio frequency processing unit 102. The power monitor unit 112 is connected with a power control unit 111, which is a part of the CPU 103 in this embodiment. A power amplify circuit 104 is connected between the power control unit 111 and the antenna duplexer 101. The power monitor unit 112 is connected with the light-emitting control circuit 121 which controls the display device to exhibit radiation intensity of the electromagnetic wave to a user. In this embodiment, the display device may be a display lamp 122. In addition, a systematic power source 105 is provided for supplying electricity to the power amplify circuit 104 and the CPU 103.

When the antenna duplexer 101 is alternatively supposed to receive a signal, for example, the received signal will reach the radio frequency processing unit 102. The radio frequency processing unit 102 is used to modulate the received signal and then send the modulated signal to the CPU 103. Then the power control unit 111 sends a control signal to the power amplify circuit 104. Meanwhile, the power monitor unit 112 samples the control signal to form a sampled signal which is fluctuated with a radiation power of the mobile phone, thus a comparison between the radiation power and a standard power can be further made by the power monitor unit 112 to produce a high or low state, referred to as a state signal I representing the high state or a state signal 0 representing the low state. The state signal 1 or 0 enters into the light-emitting control circuit 121 to control the display lamp 122 to show as bright or dark.

When the radiation power value of the mobile phone is bigger than the standard power value, P>P₀ for short, the power monitor unit 112 exhibits the high state, namely the state signal 1. The light-emitting control circuit 121 receiving the state signal 1 will drive the display lamp 122 to display brightness, which implies that the radiation intensity of the electromagnetic wave of the mobile phone is strong and is not appropriate for a user to use the mobile phone. When P is less than or equal to P₀, the power monitor unit 112 exhibits the low state, namely the state signal 0. The display lamp 122 controlled by the light-emitting control circuit 121 receiving the state signal 0 is dark, which means that the radiation intensity of the electromagnetic wave of the mobile phone is in a safe range of use, and that the user can take his ease to use the mobile phone.

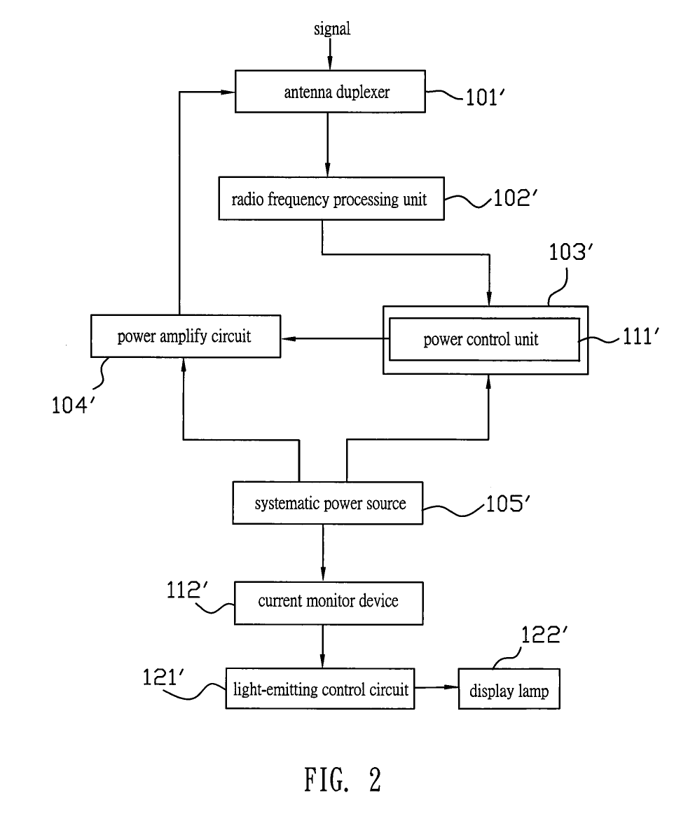

Please refer to FIG. 2, a system for monitoring radiation intensity of electromagnetic wave of the mobile phone in accordance with the second embodiment of the present invention is shown. In comparison with the first embodiment of the present invention, the arrangement of the system in the second embodiment is the same as that of the system in the first embodiment except for a power monitor unit. The power monitor unit is disposed between the systematic power source 105′ and the light-emitting control circuit 121′, including a current monitor device 112′ for monitoring a current of the systematic part in the mobile phone.

Since the power is the multiplication of the voltage and the current, when the voltage of the systematic part is rated, the power is in direct proportion to the current. The current monitor device 112′ is able to gain current values of the systematic part and compare the resulting current values with a standard current value. When the resulting current value is greater than the standard current value, I>I₀ for short, the current monitor device 112 generates a signal of high state, namely the state signal 1. The light-emitting control circuit 121′ receiving the state signal 1 will drive the display lamp 122′ to exhibit brightness, which implies that the radiation intensity of the electromagnetic wave of the mobile phone is strong and is not appropriate for the user to utilize the mobile phone. When the value I is less than or equal to the value I₀, the signal from the current monitor device 112 exhibits the low state, namely the state signal 0. The display lamp 122′ is dark when the light-emitting control circuit 121′ receives the state signal 0, which means that the radiation intensity of the electromagnetic wave of the mobile phone is in a safe range of use, and that the user can take his ease to use the mobile phone.

As described above, the power monitor unit may monitor the radiation power or the current of the systematic part and compare the radiation power or the current with the standard power or the standard current to produce the state signal 1/0 and transmit the state signal 1/0 to the lighting-emitting control circuit for making the display lamp bright or dark. Therefore, the user can know about the radiation intensity of the electromagnetic wave of the mobile phone through the brightness and dark of the display lamp and accordingly, utilize the mobile phone when the radiation intensity of the electromagnetic wave of the mobile phone is weak.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A system for monitoring radiation intensity of electromagnetic wave of a mobile phone, comprising:
a systematic part including an antenna duplexer, a central processing unit, a radio frequency processing unit disposed between the antenna duplexer and the central processing unit, a power amplify circuit connected between the central processing unit and the antenna duplexer, and a systematic power source connected with the central processing unit and the power amplify circuit;
a power monitor unit connected with the systematic part, the power monitor unit capable of monitoring a power or a current of the systematic part and comparing the power or the current with a standard power or a standard current to produce a state signal;
a display device; and
a light-emitting control circuit connected with the power monitor unit and the display device, the light-emitting control circuit receiving the state signal from the power monitor unit and driving the display device to show information corresponding to the state signal.

2. The system as claimed in claim 1, wherein the central processing unit includes a power control unit connected with the power amplify circuit, the power monitor unit is connected with the power control unit for monitoring the power of the systematic part and comparing the power with the standard power to produce the corresponding state signal.

3. The system as claimed in claim 1, wherein the power monitor unit has a current monitor device connected between the systematic power source and the light-emitting control circuit for monitoring the circuit of the systematic part and comparing the circuit with the standard circuit to produce the corresponding state signal.

4. The system as claimed in claim 1, wherein the display device is a display lamp.
